(19) United States
(12) Patent Application Publication
(10) Pub. No.: US 2011/0254682 A1
(43) Pub. Date: Oct. 20, 2011

(54) HAND HYGIENE SYSTEM

(75) Inventor: Daniel Sigrist Christensen, Kolding (DK)

(73) Assignee: Clean Contact ApS, Kolding (DK)

(21) Appl. No.: 13/132,525

(22) PCT Filed: Dec. 17, 2009
(86) PCT No.: PCT/EP2009/067461

§ 371 Date: Jul. 7, 2011

Related U.S. Application Data
(60) Provisional application No. 61/138,530, filed on Dec. 18, 2008.

(51) Int. Cl. G08B 1/08; G06K 7/01

(52) U.S. Cl. 340/539.12; 340/10.1

(57) ABSTRACT

There is provided a system for monitoring hygiene compliance in a medical facility. The system includes personnel tags for patients and for healthcare workers within the facility; sensors, to be carried by healthcare workers, which recognize personnel tags for patients within a distance of 1 meter; washing stations provided with tags which are recognized by said sensors within a distance of 0.5 meter; and a control unit, to be carried by the healthcare workers, said control unit being programmed to detect whether a healthcare worker bearing one of the personnel tags accessed a washing station prior to contacting a patient bearing a separate one of the personnel tags.

### TECHNICAL FIELD

The present invention relates to hand hygiene systems and more specifically to hand hygiene monitoring systems.

### BACKGROUND OF THE INVENTION

Acquisition of infection by hospital patients is a serious healthcare problem. The World Health Organization and other health care organizations and agencies encourage health care workers to practice proper hand hygiene to reduce the transmission of pathogens via hands. Recommended procedures include the decontamination of the hands prior to direct patient contact, prior to invasive non-surgical procedures, prior to gloving, after contact with body fluid, mucous membranes, non-intact skin and wound dressings, intact skin and inanimate objects near patients.

These procedures apply in hospital settings, doctors offices, and anywhere where these personnel come into contact with patients. Furthermore, it is generally recommended that visitors to such patients also practice proper hand washing procedures. In some instances, application of an antimicrobial preparation to the hands is substituted for a hand washing. In any event, the goal is to reduce the microbe load on the healthcare providers hands and prevent contamination of either the patients or healthcare providers.

Approximately 1 in 10 people admitted to hospitals in the United States acquire a new infection during their stay. These nosocomial infections result in an estimated 100,000 deaths per year in the United States. Nosocomial infections increase the length of patient stays in hospital, contributing to increased healthcare staffing levels, increased costs and increased use of resources. This situation contributes significantly to the overall stress on the healthcare systems and increases wait times. It is estimated that approximately half of these nosocomial infections are the result of inadequate hand hygiene compliance by healthcare staff.

There is considerable evidence that hand hygiene compliance is a primary means to reduce nosocomial infections and the transmission of pathogens. Pathogens are normally present on the skin of healthcare workers and patients and on surfaces surrounding the patient. These organisms can be transferred to healthcare workers' hands where they can survive for periods ranging from minutes to hours. The final step in the transmission process is the transfer of organisms from the contaminated hands of the caregiver to other patients or clean environmental surfaces. Alcohol-based hand rubs seem to be significantly more effective than washing with soap and water and in the reduction of transmission of pathogens.

Wearable dispensers of alcohol-based hand rub can provide ready access hand hygiene without the need to visit a fixed hand washing station and can reduce the time required to perform hand hygiene especially for busy staff such as nurses.

Unfortunately, published studies have generally found that compliance with hand hygiene requirements by healthcare workers averages about 40%. Various traditional educational and management interventions can increase awareness and improve this in the short term but generally do not provide sustainable improvements.

Some prior art systems such as U.S. Pat. No. 5,392,546 entitled “Hand Washing Compliance Measurement and Monitoring System” monitor compliance but have several possible disadvantages. A possible disadvantage of the system is that there is either no prompting of the user when it is necessary to perform hand washing, or the user is prompted every time they enter a zone, irrespective of whether they performed appropriate hand washing or not. Neither scenario would seem to encourage the user or caregiver to improve hand washing compliance.

Radio Frequency Identification technology (RFID) has been used extensively in encoding personnel identification tags. There are two types of RFID: (1) the passive transmitter type which does not have an internal power source to broadcast its identification code and requires charging electromagnetically to achieve transmission of its ID codes, i.e. the ID tag must be placed close to the reader with such charging antenna; (2) the active transmitter with built-in battery to continuously broadcast its ID codes for a reader to decode.

The passive RFID type (commonly used by credit/debit cards for retail transactions) is not suitable for a hand hygiene monitoring system, since it will require the wearer to handle his/her ID tag and place it close to a RFID reader. For a healthcare worker, this extra step will mean he/she handles the ID tag at least 10 to 20 times an hour and usually with unclean hands.

By using the active RFID type, the ID tag transmitting its unique ID code at a frequency (such as at 2.4 GHz) can be read at a distance by the reader tuned into the same frequency, thus eliminating the extra step of bring the tag to the close proximity of a reader. However, when a RFID reader is located in a wash basin (either integrated into a soap dispenser or being an independent unit by itself) with several persons wearing active RFID tags standing in front of the basin or walking nearby, the reader will record the ID codes of all those tags and unable to distinguish who is the person actually doing the handwashing. Alternative technology such as frequency hopping to enable the reader/detector to detect up to several thousand unique ID signals each at slight different frequency will read/detect all the ID tags within its range in a second. However, this reader/detector still can not distinguish who the person is actually doing the handwashing. Same situation arises for worker wearing active RFID tag to use a rinse-free disinfectant dispenser to clean his/her hands. A reader will very likely make mistakes in identifying the person undergoing hand cleaning procedure when more than one person is around or just walking by the dispenser.

The invention described here provides the simplest means of accuracy in identifying the person conducting the hand hygiene event.

Also, none of these arts stipulated a method of distinguishing the persons when 2 or more people dispensing soap or rinse-free disinfectant sequentially within a few seconds from one another at a single wash basin or rinse-free disinfectant dispenser (such as during a shift change). Furthermore, multiple persons' presences in a patient room, such as in a teaching hospital during a doctors round with several students in tow, creates the necessity of correctly identify the hand hygiene status of each person. These are the critical situations a monitoring system must handle accurately to be useful, but none of them were addressed by the prior arts cited.

Since every worker prefers to be reminded on performing a hand hygiene procedure prior to certain tasks rather than just being given a negative grade for forgetting to do so, it is essential for the monitoring system to be able to provide timely proactive prompts to remind the worker instead of just recording the failure. Furthermore, the prompts should be unobtrusive, so they will not embarrass the workers or disrupt the working relationship with customers or between patients and their care takers. Many of the commercial systems and prior arts use flashing beacons and audible alarms as reactive prompts, thus totally destroying the chance of acceptance by workers as well as reducing its effectiveness to nothing. The proactive prompting of this invention fulfills the purpose of reminding a worker to conduct hand hygiene on a timely and unobtrusive manner, but also repeat the reminder to assure compliance rather than simply recording a failure to do hand hygiene as required.

Accordingly, an improved system and method to encourage increased hand hygiene compliance in environments where the transfer of pathogens can be dangerous, remains highly desirable.

### SUMMARY OF THE INVENTION

It is therefore an object of the present invention to provide an improved system and method to encourage increased hand hygiene compliance by increased convenience and appropriate prompting when needed. A system of the present invention provides for evaluating hand hygiene compliance in a medical care facility.

The invention provides a method, a system, and system components that are designed to promote safe and hygienic practices within a hospital or other health care facility.

A method according to the invention includes detecting with a proximity sensor whether a person such as a health care worker or other visitor is in close proximity to or in contact with a patient. The term “close proximity” may be defined as being within arms length of a patient support apparatus such as a hospital bed, a stretcher, a crib or the like upon which the patient is positioned, which may be a somewhat greater distance from the patient himself. The method further includes determining whether the person has actuated a sanitizing device such as a hand sanitizer. A caution and/or warning signal, which can take many forms and cause any of a number of selected responses, is generated if the person is in close proximity or in contact with the patient and has not actuated the hand sanitizer. Depending on how the system is programmed, the caution or warning signals generated could cause the illumination of an indicator device or a text message to be displayed that reminds the person to wash his hands, advises the person and/or others that a violation has occurred, or instructs the person to vacate the patient care area.

Accordingly, an aspect of the present invention provides a system for monitoring hygiene compliance in a medical facility, comprising:
personnel tags for patients and for healthcare workers within the facility;
sensors, to be carried by healthcare workers, which recognize personnel tags for patients within a distance of 1 meter, preferably 0.75 meter, more preferably 0.5 meter, and most preferably 0.25 meter;
hand cleaning stations provided with tags which are recognized by said sensors within a distance of 1 meter;
a control unit, to be carried by the healthcare workers, said control unit being programmed to detect whether a healthcare worker bearing one of the personnel tags accessed a washing station prior to contacting a patient bearing a separate one of the personnel tags or ID bands.

In a preferred embodiment the system according to the present invention further comprises an infrared thermosensor attached to the sensors carried by the healthcare workers. This thermosensor is preferably focused onto the operational area of the healthcare worker's hand; this can be achieved by fixing the thermosensor (together with the sensors to be carried by the healthcare workers) on the wrist of the healthcare worker.

Preferably, each personnel tag will have a unique personnel identifier, making possible the tracking of specific patient healthcare worker interactions. Individual hand cleaning stations can also bear unique identifiers.

Hand cleaning stations can include hand washing stations, such as a sink with a soap dispenser, and can also include anti-microbial hand rub dispensers. Preferably, they also include an actuation sensor for sensing not just presence but actual use of the hand hygiene station, the actuation sensor being linked to the control means.

The personnel tags comprise a machine readable sensor, such as an RFID tag. Hand hygiene status of a user bearing the personnel tag is preferably stored on the personnel tag itself.

The control unit comprises a processor, which records the number of patient interactions, the number of patient interactions where proper hand hygiene was practiced, the number of interactions where proper hand hygiene was not practiced, and whether proper hand hygiene was practiced after a patient interaction.

Preferably, the control unit incorporates some form of alarm which can provide a warning if a personnel tag of a healthcare worker having a status other than “clean” approaches a personal tag of a patient. The warning can be both audible and visual.

Preferably, the personnel tags comprise a status indicator to indicate the hand hygiene status of its bearer. Such a status indicator can provide a visual indication of the hand hygiene status and also provide an audible indication of a change in status, or an audible warning of improper patient contact.

The system preferably stores a hand hygiene status of a user, such as “clean” or “potentially contaminated.” This status changes from “clean” after contact with a patient. It will also change from “clean” after a predetermined time regardless of patient contact.

Thus, in a preferred embodiment of the present invention the personnel tags worn by the healthcare workers comprise a status indicator to indicate a hand hygiene status of the healthcare worker. Preferably, the status indicator provides a visual indication of the hand hygiene status, wherein the status indicator provides an audible indication of a change in status. Preferably, the status indicator provides an audible warning when the personnel tag is within a defined proximity of a personnel tag of a patient and the hand hygiene status is other than “clean”.

A preferred embodiment of the present invention further provides a device that can detect whether or not a healthcare worker has contacted the skin of a patient, a visitor, or another healthcare worker. This device can be embodied in the system described above or it can be implemented as an independent system to determine potentially infectious skin contact, e.g. when a healthcare worker conducts wound caring interventions or similar activity, wherein the skin of another person is contacted. The detection of skin contact in accordance with this embodiment may be achieved through one or more of the technologies Galvanic Skin Response (GSR), Detection of Temperature Changes, ElectroDermal Response (EDR), Motion Pattern Recognition (MPR), and ElectroMyoGraphy (EMG).

GSR is a measure of the skin's conductance between two electrodes. Electrodes are small metal plates that apply a safe, imperceptibly tiny voltage across the skin. In the present invention the electrodes are typically attached to the finger(s) of the healthcare worker using silver-Chloride electrode patches. To measure the resistance, a small voltage is applied to the skin and the skin's current conduction is measured. When the healthcare worker contacts skin of another person the conductance measured by the GSR device changes abruptly indicating that skin contact has taken place.

The electromyogram (EMG) measures muscle tension. Two electrodes (or sensors) are placed on the skin over the muscles of the under arm of the healthcare worker to be monitored; muscle activity in the wrist indicates that the hand is being used for e.g. shaking hands with patient or wound care.

Like monitoring muscle tension, measuring skin temperature is a useful tool to determine if the healthcare worker has contacted a patient. The skin temperature sensor should be placed adjacent to the hand, e.g. on the wrist, and monitor if the temperature in the area around the hand increases, indicating that the healthcare worker is in close proximity with the skin of a patient, a visitor or another healthcare worker.

ElectroDermal Response (EDR) involves the measurement of skin conductivity or resistance. Since the EDR changes upon skin contact between two persons it can similarly be used to indicate that e.g. e healthcare worker has been potentially contaminated by patient contact.

Also detection of a specific motion pattern of the wrist can be used to determine whether or not a healthcare worker has contacted e.g. a patient during a wound caring operation. This technology is herewith referred to as Motion Pattern Recognition (MPR).

In an alternative embodiment of the present invention a unit for determining the position and movement of the wrist in 3D is used to determine skin contact. In this respect it should be noted that the movement pattern of the wrist is unique when the healthcare worker shakes hand with e.g. a patient, or when doing wound caring operations. For the determination of the position and movement of the wrist the present invention contemplates a unit comprising an accelerometer component operative to perform acceleration measurements along 3 orthogonal axes, and a gyroscopic component operative to measure rotational velocity along said 3 orthogonal axes.

In still another embodiment of the present invention skin contact is detected by providing transmission means to the healthcare worker capacitively coupled to ground; providing receiving means to the patient capacitively coupled to ground, said receiving means exhibiting a detectable electrical characteristic representing information; and operating the transmission means to pass, across the healthcare worker's body, a time-varying signal having a magnitude sufficient to be detected by the receiving means when said patient is contacted by the healthcare worker. Importantly the patient bears a receiver with a personalised ID tag. In this embodiment physical contact and hence potential contamination will be detected. Specifically this is achieved since the receiving means is provided with an ID tag that is transmitted to the healthcare worker and detected through second receiving means attached to the patient when said healthcare worker and said patient approach and/or contact each other. In such a case the invention provides for an alarm or other means for alerting the health care staff member to perform a hand cleaning manoeuvre in accordance with the above.

By using appropriate electronics and instruction sets, this invention delivers a hand hygiene monitoring system that provides:
continuous monitoring,
timely unobtrusive reminder to the staff to wash or clean hands,
no disruption to the regular work flow or handwashing procedure,
absolute accuracy in identifying a person undergoing handwashing or cleaning.

It is a system that can deliver the performances demanded by healthcare settings, food services, hotels, cruise ships, spas and fitness/gyms to minimize cross infection by staff due to lack or improper hand hygiene.

### BRIEF DESCRIPTION OF THE DRAWINGS

FIG. 1 shows a diagram of a hygiene monitoring system which incorporates various features of the present invention therein.

FIG. 2 shows a wrist and hand of a healthcare worker equipped with an RFID sensor (transceiver) and a thermosensor for detecting patient contact.

FIG. 3 is a generalized representation of intra-body and inter-body power and data transmission in accordance with the present invention

FIG. 4 shows a graphical simplified representation of the signal transmitted, the signal received before skin contact, and the signal received after skin contact.

### DETAILED DESCRIPTION OF THE INVENTION

It should be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected”, “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Furthermore, and as described in subsequent paragraphs, the specific mechanical configurations illustrated in the drawings are intended to exemplify embodiments of the invention. However, other alternative mechanical configurations are possible which are considered to be within the teachings of the instant disclosure. Furthermore, unless otherwise indicated, the term “or” is to be considered inclusive.

Various embodiments of the present invention will now be described with reference to the figure.

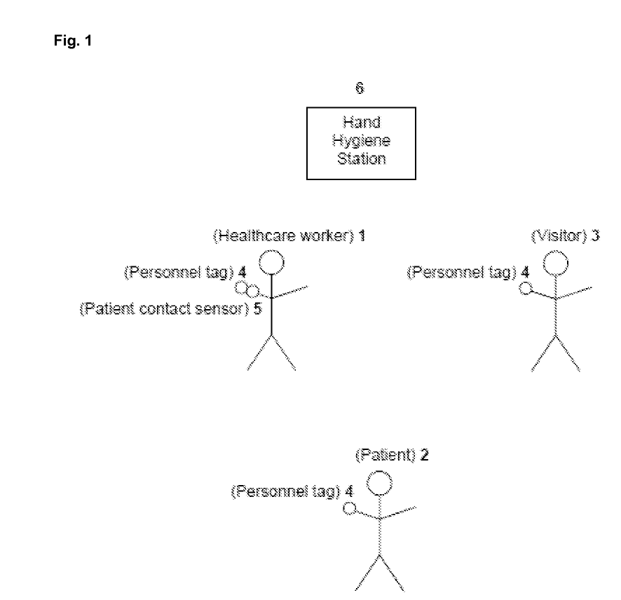

FIG. 1 illustrates a hand hygiene compliance system for a healthcare facility. Persons within the facility such as a healthcare worker 1, patient 2 or visitor 3 are each provided with a personnel tag 4, which incorporates a unique identifying number. The tag is fixed to the wrist, e.g. by incorporating it into a bracelet. The tag preferably incorporates some form of proximity locator or local communication means. For instance, in a preferred embodiment of the invention, the tag incorporates a Radio Frequency Identification (RFID) tag.

Patient contact is determined by a sensor 5 located adjacent to the personal tag of the healthcare personnel to detect the approach of personnel tags carried by patients and other healthcare workers. Multiple sensors and sensors of different types may be employed. For instance, a passive infrared radiation (IR) sensor which detects the approach of a person's hand can be employed along with an RFID transceiver for reading the RFID tag in the personnel tag.

The RFID transceiver 5 on the healthcare worker may have a range equivalent to the desired perimeter. The perimeter is preferably about 1 meter from the other personal tags. If it is too far it might falsely register a contact and if it is too small it might fail to register a contact. The RFID transceiver may also be set with an additional more narrow perimeter, such as 10 cm, indicating that the healthcare worker has shaken hands with a patient, a visitor or another healthcare worker.

Other machine readable tagging systems may be employed. RFID tags are particularly suitable for this application as they are inexpensive, can be read at a distance and some types can have data written to them and updated.

Hand cleaning stations 6 (such as an antimicrobial hand rub dispenser or hand wash station, such as a sink with running water and a supply of soap or detergent for hand washing) are provided with an RFID transponder 7, which is recognized by the transceiver of the healthcare worker, when he or she use the hand cleaning station.

Preferably, the RFID transceiver is tied through some form of communication to a central data processing station. That communication could take the form of a radio frequency communication.

In its basic operation, the system for monitoring hygiene compliance of the present invention employs the RFID transceiver along with the personnel tags to help ensure that a healthcare worker who approaches a patient has either washed his/her hands or applied an antimicrobial hand rub to reduce the chance of infecting a patient. This can be implemented in many different fashions. One simple implementation would detect the person's presence at a hand cleaning station and then signal either to the RFID tag or to a central processor, or to both, that the person's status was now “clean”.

Preferably, the tag of the healthcare worker is equipped with a display of some fashion with an audio output device. The display could be as simple as one or more color-coded lights, preferably labelled. Therefore, when the healthcare worker approached the patient the display would indicate such as by a green light or display of the status “clean” that the person had attended to hand hygiene prior to visiting that patient.

If the status is not “clean” but is rather “potentially contaminated” then the tag will indicate a warning. Preferably, the warning would include either a warning light or a warning message on the display and an audio alert such as a buzzer or more preferably voice instructions to attend to hand cleaning.

After leaving the patient, the RFID tag would now have the status “potentially contaminated”. The status “potentially contaminated” would also apply when there had not been previous contact with a hand cleaning station. Status would be changed back to “clean” upon visitation of a hand cleaning station. The “clean” status would be effective for a specified period of time assuming there is no further contact with other patients, healthcare workers or visitors.

Other implementations and data storage can be included within the invention. For instance, compliance rates for various personnel can be tracked. The tracking can be performed on the RFID tag itself or at the central processor. Reports can be generated and used to help personnel improve their compliance. Such reports might include the number of times such personnel approached a patient location with a status other than “clean” within a given time period. It could also track which patients were approached and be compared against patient records to track transmission of infections within the institution.

Compliance at a hand cleaning station 6 can either be assumed by presence, assumed by presence for a given amount of time or verified with a sensor at the hand hygiene station such as a sensor which reads when soap is dispensed at a hand wash station or a sensor which reads when an antimicrobial hand gel has been dispensed at a hand rub dispenser. Such sensors would be important when the hand hygiene station comprises a portable antimicrobial hand rub dispenser worn on the body of the user.

Hand hygiene procedures typically require a certain length of scrubbing at hand wash stations and the time of water running after dispensing of the soap might also be measured. A proximity sensor, especially one already used to turn on water flow, might also be polled to see if hands are in the stream of the water.

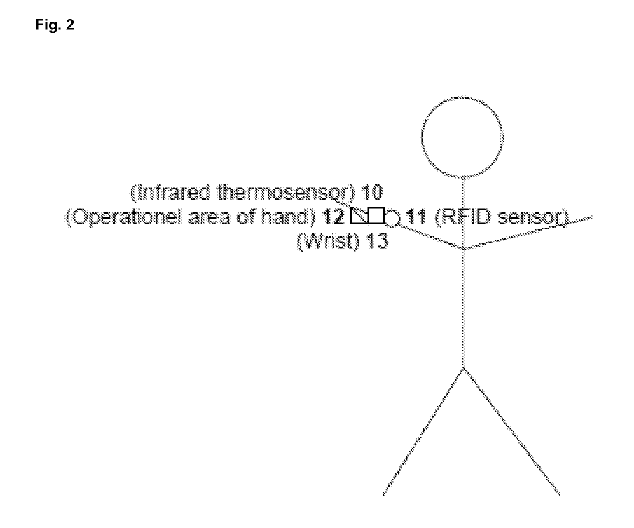

FIG. 2 shows a preferred embodiment of the system according to the present invention. In this embodiment the system further comprises an infrared thermosensor 10 attached to the sensor 11 carried by the healthcare workers. This thermosensor is preferably focused onto the operational area 12 of the healthcare worker's hand; this can be achieved by fixing the thermosensor (together with the sensors to be carried by the healthcare workers) on the wrist 13 of the healthcare worker.

A person wearing his/her ID band undergoing a handwashing procedure will place his/her hand wearing the ID band under the soap dispenser to trigger e.g. an infrared proximity sensor for activating the dispensing motor as well as an intelligent controller board. The active ID band will be transmitting at very low power (in 1 to 3 microwatts range, thus the signal can only be read by a dispensers RF transceiver circuitry at no greater than 1 meter, preferably 0.5 meter, and most preferably 0.25 meter in distance) a data string containing its personnel ID code and the last time the wearer performed a hand hygiene procedure at 2 Hz or faster repetition rate continuously.

While the dispensing motor is turning (or during the depressing of the manual dispensing tab), the intelligent controller board of the soap dispenser is activated to receive the personnel ID code from the ID band along with the data of the most recent handwashing or cleaning of the wearer. If two different people place their hands (which is not very likely) within e.g. 0.5 meter of the soap dispenser at the same time, the controller board will select the ID code belonging to the person with longer time lapse from his/her last hand hygiene event. The controller board then adds this personnel ID code as the lead element to its own dispenser ID codes and transmits back to the ID band. This transmission is at higher power (in 2 to 3 milliwatts range) and at 2 Hz or higher repetition rate for a duration of 2 seconds to enable an ID band to receive this signal at a distance up to 1.5 meter. Any other person wearing an ID band standing next to the person who just dispensed soap or walking by within the 1.5 meter radius will not be able to decipher the identification code of the soap dispenser, since it does not have the same personnel ID code as the lead element. The ID band of the person undergoing the handwashing procedure will record the identification code of the soap dispenser along with the time-date from its internal programmable clock circuitry as the first piece of data constitutes a handwashing event record.

The intelligent controller board of the soap dispenser will also start a timer from the moment the dispenser is triggered. Every 5 seconds, it will transmit a timing mark with the personnel ID code of the triggering ID band as the lead element. It will do so until 5 to 6 timing mark signals are transmitted. The number of timing marks can be altered to enforce longer hand scrubbing and rinsing as dictated by the institution implementing this invention. During the first 10 or 15 seconds period, the controller board will flash “SCRUB” on the display panel on the front of the dispenser; then it will flash “RINSE” on the display panel for the next 10 or 15 seconds period. Again, the amount of time for scrubbing and rinsing can be customized by the institution implementing this proactive hand hygiene monitoring system. The ID band of the person undergoing the handwashing procedure will record these timing marks to signify that the wearer has or has not gone through the proper handwashing steps, i.e. at least 10 seconds of scrubbing with soap and 10 seconds of rinsing with water before walking away from the wash basin. The 5 and/or 6 (or more) timing marks constitute the second piece of data of a handwashing event.

The third piece of data is performed by the ID band of the person undergoing the handwashing procedure. Upon receiving the 5 and/or 6 timing marks, it will assign a “Pass” grade and duration of 30 seconds to the event. If the last two timing marks (the 20^{th}/25^{th} or 25^{th}/30^{th} second) are missing, then a “Fail” grade and duration of less than 20 seconds is recorded for this event. After issuing the 5^{th} or 6^{th} timing mark, the controller board will enter the soap dispenser into standby mode to conserve battery power.

Occasionally, a person may want additional soap aliquot after the initial dispensing; the intelligent controller board will treat the second dispensing as a single handwashing event if the demand of second aliquot occurs within 2 seconds of the first one. All the subsequent timing marks and transmitting of signal will still be based on the timing of the first dispensing and on the personnel code of the ID band already read. However, if the dispensing triggering is occurred after 2 seconds, then the intelligent controller will read the ID band code again to see whether its is still the same person. If it is the same person, the above described process will be continued. If it is not the same person, the controller board will run a parallel operation of two persons washing hands almost at the same time at the same wash basin. Again, there is no confusion of data recorded by prospective ID band, since the dispenser will issue its own ID codes and timing marks with two separate personnel ID band codes as lead elements.

A pulsed infrared proximity sensor mounted on the front of the soap dispenser will sense people within its 1.5 meter or longer detection range. Upon sensing a person, it will activate the RF transceiver to broadcast a proactive “CHECK” signal. Any person wearing an ID band within 1.5 meter of the soap dispenser will receive this signal, and his/her ID band will check the last time he/she had washed or cleaned hands. If the designated time length (determined by the institution's hand hygiene guidelines) is exceeded, then the ID band will issue a prompt (vibration or low tone) to remind the person walking by the wash basin to wash. If a prompt is issued, compliance and non-compliance is recorded by the if) band with time-date. If no hand hygiene action is required, then no record is entered. This approach makes the proactive prompting and monitoring totally transparent to the worker to eliminate any disruption of his/her work routine when no action is required. Since each person has his/her ID band, it will react to the prompt independently, therefore, the number of persons present next to the wash basin and the soap dispenser will not influence its effectiveness in prompting individual worker to comply to the hand hygiene guideline.

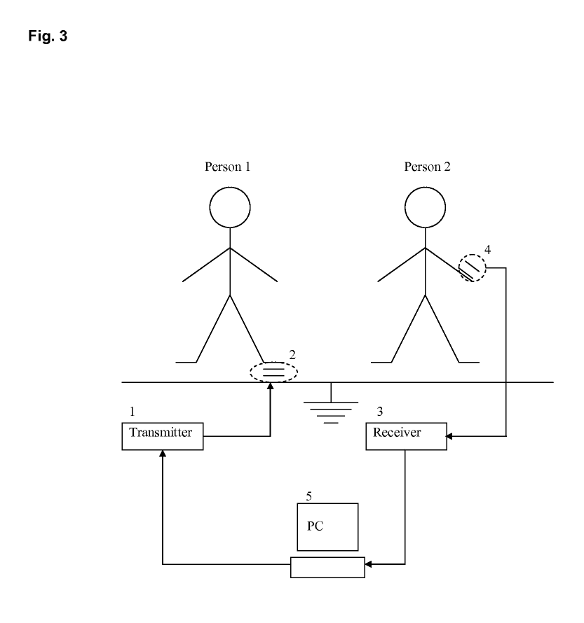

FIG. 3 is a generalized representation of intra-body and inter-body power and data transmission in accordance with the present invention, reflecting capacitive coupling of displacement current into the body and the use of the environment as the current return path. The schematic arrangement shown in FIG. 3 is valid for both intrabody and interbody modes of capacitive coupling. In the figure, a transmitter applies an AC signal to the body of a user via capacitive coupling, represented as a capacitance. This signal passes through the user's body to a receiver mounted on another person's body; before contact via a capacitive electrostatic linkage, and upon contact via both a capacitive electrostatic linkage and a galvanic linkage (i.e. the signal becomes both capacitively and/or galvanically coupled resulting in a phase shift). The transmitter and receiver are all capacitively coupled to the ambient ground. The respective capacitances can be a combination of air and earth ground, and materials in the vicinity of the persons can contribute. Generally, the noted capacitances are on the order of 1-10 pF. Not shown in the figure are various parasitic capacitances. These are usually negligible but, depending on the configuration, can interfere with operation.

Specfically in FIG. 3 a transmitter (1) is connected to a plate capacitor (2) embedded in a shoe warn by person 1. The transmitter excites the plate capacitor with an AC voltage signal at a specific frequency controlled by the connected computer (5). By means of this arrangement person 1 now emits an AC electric field (E) throughout the entire body to the surroundings.

Person 2 is connected to a plate capacitor (4) embedded in a wrist watch. The signal picked up by plate capacitor (4) is fed to a receiver (3), which amplifies the desired frequency of interest. This signal is then fed to a PC (5) for further processing and displaying the signal picked up.

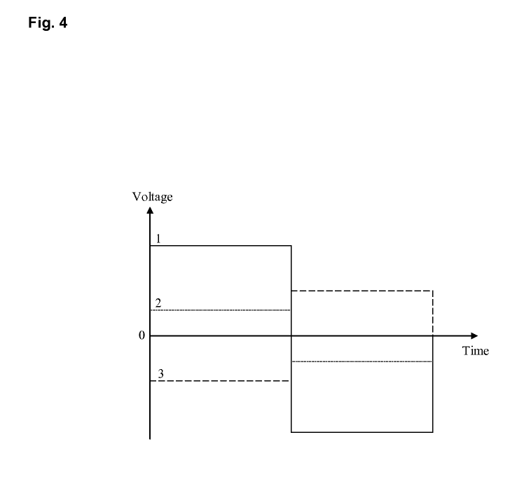

FIG. 4 shows a graphical simplified representation of the signal transmitted (1), the signal received before skin contact (2) and the signal received after skin contact (3). As seen in FIG. 4 a phase shift in the received signal is observed in respect to the transmitted signal (1), when person 1 touches (makes skin contact to) person 2.

In an interbody coupling configuration, the transmitter in the first person is physically displaced from the second person. The second person becomes electrostatically coupled to first person (equipped with transmitter electrode) as she/he approaches. Without the human body as an electrostatic conduit, capacitive coupling between the transmitter and receiver would be negligible unless brought within centimeters of each other. The body effectively extends the coupling range. When the bodies become contacted the signal changes phase, which is used to send an ID signal from the patient back to the healthcare worker.

In an alternative approach, the user's body is employed as a two-way transmission channel, and the worn device actually transmits information (rather than simply modulating detectable electrical characteristics).

1. A system for monitoring hygiene compliance in a medical facility, comprising:
personnel tags, such as RFID tags, for patients and for healthcare workers within the facility;
sensors, to be carried by healthcare workers, which recognize personnel tags for patients within a distance of 1 meter;
washing stations provided with tags which are recognized by said sensors within a distance of 0.5 meter;
a control unit, to be carried by the healthcare workers, said control unit being programmed to detect whether a healthcare worker bearing one of the personnel tags accessed a washing station prior to contacting a patient bearing a separate one of the personnel tags.

2. A system according to claim 1, wherein the personnel tags worn by the healthcare workers comprise a status indicator to indicate a hand hygiene status of the healthcare worker.

3. A system according to claim 2, wherein the status indicator provides a visual indication of the hand hygiene status.

4. A system according to claim 2, wherein the status indicator provides an audible indication of a change in status.

5. A system according to claim 2, wherein the status indicator provides an audible warning when the personnel tag is within a defined proximity of a personnel tag of a patient and the hand hygiene status is other than “clean.”

6. A system according to claim 1, wherein the sensor further comprises an infrared thermosensor focused onto the operational area of the healthcare worker's hand.

7. A system according to claim 1, wherein the sensor is fixed to the healthcare workers wrist.

8. A system for monitoring hygiene compliance in a medical facility, comprising:
devices for detecting skin contact between healthcare workers, patients and visitors within the facility;
washing stations provided with tags which are recognized by sensors, to be carried by healthcare workers, within a distance of 0.5 meter;
a control unit, to be carried by the healthcare workers, said control unit being programmed to detect whether a healthcare worker accessed a washing station after having had skin contact with a patient, a visitor or another healthcare worker.

9. A system according to claim 8, wherein the device for detecting skin contact is selected from one or more of the technologies Galvanic Skin Response (GSR), Detection of Temperature Changes, Motion Pattern Recognition (MPR), ElectroDermal Response (EDR), and ElectroMyoGraphy (EMG).

10. A system according to claim 9, wherein the device is based on GSR.

11. A system according to claim 8, wherein the device is placed on the wrist of the healthcare worker.

12. A system according to claim 8 in combination with a the system for monitoring hygiene compliance in a medical facility, comprising:
personnel tags, such as RFID tags, for patients and for healthcare workers within the facility;
sensors, to be carried by healthcare workers, which recognize personnel tags for patients within a distance of 1 meter;
washing stations provided with tags which are recognized by said sensors within a distance of 0.5 meter;
a control unit, to be carried by the healthcare workers, said control unit being programmed to detect whether a healthcare worker bearing one of the personnel tags accessed a washing station prior to contacting a patient bearing a separate one of the personnel tags.
